(19) United States
(12) Patent Application Publication
(10) Pub. No.: US 2013/0166929 A1
(43) Pub. Date: Jun. 27, 2013

(54) POWER SUPPLY SYSTEM FOR MEMORY MODULES

(71) Applicants: BO TIAN, Shenzhen City (CN); KANG WU, Shenzhen City (CN)

(72) Inventors: BO TIAN, Shenzhen City (CN); KANG WU, Shenzhen City (CN)

(21) Appl. No.: 13/648,631

(22) Filed: Oct. 10, 2012

(30) Foreign Application Priority Data
Dec. 23, 2011 (CN) 201110437579.4

(51) Int. Cl. G06F 1/26

(52) U.S. Cl. 713/300

(57) ABSTRACT

A power supply system includes a state detection unit, a control unit, a first voltage regulator, a second voltage regulator, a first group of memory slots, and a second group of memory slots. The first voltage regulator supplies power to memory modules connected to the first group of memory slots. The second voltage regulator supplies power to memory modules connected to the second group of memory slots. The state detection unit detects operation states of the memory modules connected to the first and second groups of memory slots. When the state detection unit detects one of the memory modules connected to the first group of memory slots is damaged, the state detection unit outputs a control signal to the control unit. The control unit controls the first voltage regulator not to supply power to the memory modules connected to the first group of memory slots, after receiving the control signal.

### BACKGROUND

1. Technical Field

The present disclosure relates to a power supply system for memory modules.

2. Description of Related Art

Many memory modules are received in memory slots in a computer system for adding storage capacity. If one of the memory modules is damaged, the computer system will not operate properly. Therefore, there is room for improvement in the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a block diagram of a power supply system for memory modules in accordance with an embodiment of the present disclosure.

FIG. 2 is a circuit diagram of the power supply system of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references can mean “at least one”.

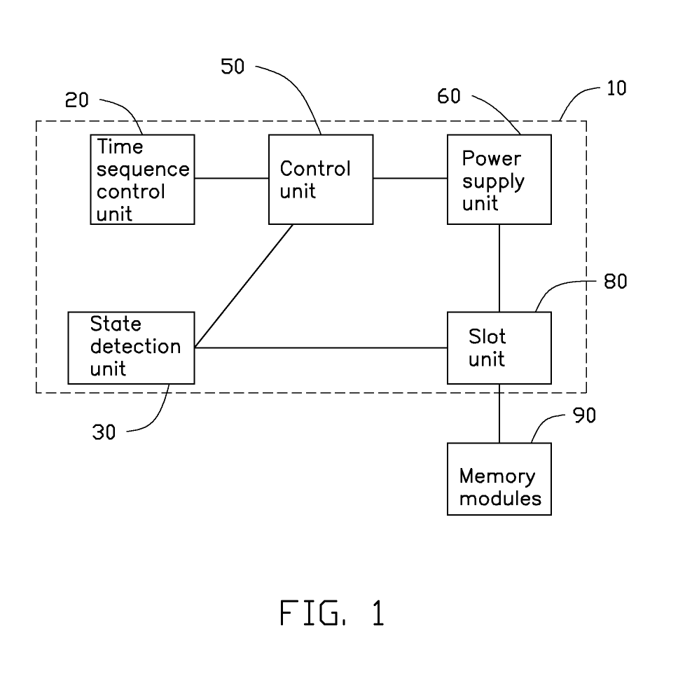

Referring to FIG. 1, an embodiment of a power supply system 10 used for supplying power to memory modules 90 is shown. The power supply system 10 includes a time sequence control unit 20, a state detection unit 30, a control unit 50, a power supply unit 60, and a slot unit 80. The control unit 50 is connected to the time sequence control unit 20, the state detection unit 30, and the power supply unit 60. The slot unit 80 is connected to the state detection unit 30 and the power supply unit 60. In one embodiment, the power supply system 10 is assembled on a motherboard of an electronic device (not shown), such as a computer or a server.

The time sequence control unit 20 is used to control boot time sequence of the electronic device, and output a high level enable signal to the control unit 50 at the moment the memory modules 90 is powered. The slot unit 80 is used to connect the memory modules 90. The power supply unit 60 is used to supply power to the memory modules 90 through the slot unit 80. The state detection unit 30 is used to detect operation states of the memory modules 90 connected to the slot unit 80, and output a control signal to the control unit 50 according to the detected result. The control unit 50 is used to control the power supply unit 60 to supply power to the memory modules 90, according to signals received from the time sequence control unit 20 and the state detection unit 30.

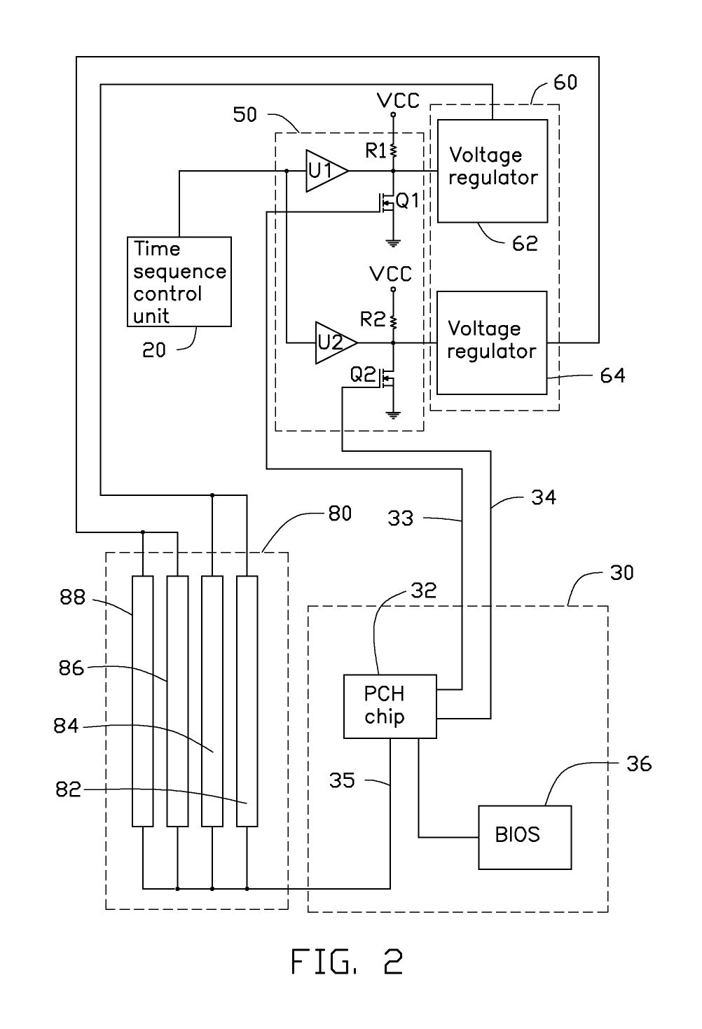

Referring to FIG. 2, the state detection unit 30 includes a platform controller hub (PCH) chip 32 and a basic input output system (BIOS) 36. The control unit 50 includes two buffers U1 and U2, two resistors R1 and R2, and two electronic switches Q1 and Q2. The power supply unit 60 includes two voltage regulators 62 and 64. The slot unit 80 includes a first group of memory slots 82 and 84, and a second group of memory slots 86 and 88.

An input terminal of the buffer U1 is connected to the time sequence control unit 20, to receive the high level enable signal. An output terminal of the buffer U1 is connected to the voltage regulator 62, to output the high level enable signal to the voltage regulator 62. An input terminal of the buffer U2 is connected to the time sequence control unit 20, to receive the high level enable signal. An output terminal of the buffer U2 is connected to the voltage regulator 64, to output the high level enable signal to the voltage regulator 64. A control terminal of the electronic switch Q1 is connected to the PCH chip 32 through a first general purpose input output (GPIO) bus 33. A power terminal of the electronic switch Q1 is connected to a power supply VCC through the resistor R1, and connected to the output terminal of the buffer U1. A ground terminal of the electronic switch Q1 is grounded. A control terminal of the electronic switch Q2 is connected to the PCH chip 32 through a second GPIO bus 34. A power terminal of the electronic switch Q2 is connected to the power supply VCC through the resistor R2, and connected to the output terminal of the buffer U2. A ground terminal of the electronic switch Q2 is grounded. The PCH chip 32 is connected to the BIOS 36, and connected to the memory slots 82, 84, 86, and 88 through a system management bus 35. The voltage regulator 62 is connected to the first group of memory slots 82 and 84. The voltage regulator 64 is connected to the second group of memory slots 86 and 88.

When the electronic device is turned on or restarted, the time sequence control unit 20 controls boot time sequence of the electronic device, and outputs the high level enable signal at the moment the memory modules 90 is powered. The high level enable signal is transmitted to the voltage regulator 62 through the buffer U1, and transmitted to the voltage regulator 64 through the buffer U2. The voltage regulator 62 supplies power to the memory modules 90 connected to the first group of memory slots 82 and 84, after receiving the high level enable signal. The voltage regulator 64 supplies power to the memory modules 90 connected to the second group of memory slots 86 and 88, after receiving the high level enable signal. The PCH chip 32 detects the operation states of the memory modules 90 connected to the memory slots 82, 84, 86, and 88, after the memory modules 90 are powered on. When the PCH chip 32 detects that the memory module 90 connected to one of the first group of memory slots 82 and 84 is damaged, the PCH chip 32 outputs the control signal to the control terminal of the electronic switch Q1 to turn on the electronic switch Q1. The high level enable signal outputted from the buffer U1 is pulled down by the electronic switch Q1. The voltage regulator 62 does not supply power to the memory modules 90 connected the first group of memory slots 82 and 84, after receiving a low level signal from the power terminal of the electronic switch Q1. That is, if the memory module 90 connected one of the first group of memory slots 82 and 84 is damaged, two memory modules 90 connected to the first group of memory slots 82 and 84 are powered off. At this time, the voltage regulator 64 supplies power to the memory modules 90 connected to the second group of memory slots 86 and 88, therefore, the electronic device can be turned on or restarted normally.

It is appreciated that, the PCH chip 32 further detects information, such as storage capacity, frequencies, types, and locations of the memory modules 90 connected to the memory slots 82, 84, 86, and 88. When the PCH chip 32 detects the memory module 90 connected to one of the memory slots 82, 84, 86, and 88 is damaged, the PCH chip 32 outputs the detected result to the BIOS 36. The BIOS 36 displays information of the damaged memory module 90 to a user. Therefore, the user can replace the damaged memory module 90.

In one embodiment, the time sequence control unit 20 is a complex programmable logic device. Each of the memory slots 82, 84, 86, and 88 is a dual in-line memory module slot. Each of the electronic switches Q1 and Q2 is an n-channel metal-oxide semiconductor field-effect transistor (NMOSFET). The control terminal, the power terminal, and the ground terminal of each of the electronic switches Q1 and Q2 are a gate, a drain, and a source of the NMOSFET. Each of the buffers U1 and U2 is used to make the high level enable signal output from the timing sequence control unit 20 more stable. In other embodiments, the buffers U1 and U2 may be omitted to save cost if stabilizing is not needed for the application. Each of the electronic switches Q1 and Q2 may be an npn bipolar junction transistor, or other switch having similar functions. The number of the groups of memory slots included in the slot unit 80 can be adjusted according to actual need. When adding one group of memory slots in the slot unit 80, the number of the voltage regulators included in the power supply unit 60 should be added by one accordingly.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A power supply system to supply power to memory modules, comprising:
a first group of memory slots comprising two memory slots to connect two of the memory modules;
a second group of memory slots comprising two memory slots to connect another two of the memory modules;
a first voltage regulator connected to the first group of memory slots, to supply power to the memory modules connected to the first group of memory slots;
a second voltage regulator connected to the second group of memory slots, to supply power to the memory modules connected to the second group of memory slots;
a control unit connected to the first and second voltage regulators; and
a state detection unit connected to the first and second groups of memory slots, to detect operation states of the memory modules connected to the first and second groups of memory slots, and connected to the control unit;
wherein the state detection unit outputs a control signal to the control unit, in response to the state detection unit detecting one of the memory modules connected to the first group of memory slots being damaged, and the control unit controls the first voltage regulator not to supply power to the memory modules connected to the first group of memory slots, in response to the control unit receiving the control signal.

2. The power supply system of claim 1, further comprising a time sequence control unit connected to the control unit, wherein the time sequence control unit outputs an enable signal to the first and second voltage regulators through the control unit, in response to the memory modules connected to the first and second groups of memory slots being powered; and wherein the first voltage regulator supplies power to the memory modules connected to the first group of memory slots, and the second voltage regulator supplies power to the memory modules connected to the first group of memory slots, in response to the first and second voltage regulators receiving the enable signal.

3. The power supply system of claim 2, wherein the enable signal is a high level signal.

4. The power supply system of claim 3, wherein the control unit comprises:
a first and a second resistors;
a first electronic switch comprising:
a control terminal connected to the state detection unit to receive the control signal;
a power terminal connected to a power supply through the first resistor, and connected to the time sequence control unit and the first voltage regulator; and
a ground terminal grounded; and
a second electronic switch comprising:
a control terminal connected to the state detection unit;
a power terminal connected to the power supply through the second resistor, and connected to the time sequence control unit and the second voltage regulator; and
a ground terminal grounded;
wherein the first electronic switch is turned on in response to the control terminal of the first electronic switch receiving the control signal, the enable signal is pulled down by the first electronic switch, the first voltage regulator does not supply power to the memory modules connected to the first group of memory slots, in response to the first voltage regulator receiving a low level signal from the power terminal of the first electronic switch.

5. The power supply system of claim 4, wherein the control unit further comprises:
a first buffer comprising an input terminal connected to the time sequence control unit, and an output terminal connected to the power terminal of the first electronic switch; and
a second buffer comprising an input terminal connected to the time sequence control unit, and an output terminal connected to the power terminal of the second electronic switch.

6. The power supply system of claim 4, wherein the state detection unit comprises a platform controller hub (PCH) chip, the PCH chip is connected to the first and second groups of memory slots, to detect operation states of the memory modules connected to the first and second groups of memory slots, and connected to the control terminals of the first and second electronic switches, the PCH chip outputs the control signal to the control terminal of the first electronic switch, in response to the PCH chip detecting one of the memory modules connected to the first group of memory slots is damaged.

7. The power supply system of claim 6, wherein each of the first and second electronic switches is an n-channel metal-oxide semiconductor field-effect transistor (NMOSFET), the control terminal, the power terminal, and the ground terminal of each of the first and second electronic switches are a gate, a drain, and a source of the NMOSFET.

8. The power supply system of claim 5, wherein the time sequence control unit is a complex programmable logic device.

9. The power supply system of claim 1, wherein each of the memory slots of the first and second groups of memory slots is a dual in-line memory module slot.
